(19) United States
(12) Patent Application Publication
(10) Pub. No.: US 2013/0282971 A1
(43) Pub. Date: Oct. 24, 2013

(54) COMPUTING SYSTEM AND DATA TRANSMISSION METHOD

(71) Applicant: HON HAI PRECISION INDUSTRY CO., LTD., New Taipei (TW)

(72) Inventor: FENG-CHI YANG, New Taipei (TW)

(73) Assignee: HON HAI PRECISION INDUSTRY CO., LTD., New Taipei (TW)

(21) Appl. No.: 13/772,396

(22) Filed: Feb. 21, 2013

(30) Foreign Application Priority Data
Apr. 24, 2012 (CN) 201210121544.4

(51) Int. Cl. G06F 13/16

(52) U.S. Cl. CPC G06F 13/1668
USPC 711/105

(57) ABSTRACT

A computing system includes a central processing unit (CPU), a first direct memory access (DMA) controller, a first bus, a memory module inserted in a first dual inline memory module (DIMM) slot, and a storage device installed on a second DIMM slot. The storage device includes a storage module, a second bus, a memory unit, an interface control unit, and a second DMA controller. The CPU sets up the first and the second DMA controllers to perform data transmission. The first DMA controller controls a first data transmission between the memory module and the memory unit through the first and the second buses, and the second DMA controller controls a second data transmission between the memory unit and the storage module, with the interface control unit, through the second bus. The disclosure further provides a data transmission method of the computing system.

### BACKGROUND

1. Technical Field

The present disclosure relates to a computing system, and particularly to a computing system with direct memory access (DMA) controllers and a data transmission method of the computing system.

2. Description of Related Art

There are several dual inline memory module (DIMM) slots for memories in a motherboard of a conventional computing system. However, in many computer systems not all of the DIMM slots are filled with memories. Thus, some of the DIMM slots are free and this means that utilization of the hardware resources of the computing system is less than optimal.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a computing system of the present disclosure.

FIG. 2 is a block diagram of an embodiment of a computing system with a storage device of the present disclosure.

FIG. 3 is a flowchart of an embodiment of a data transmission method of the present disclosure.

### DETAILED DESCRIPTION

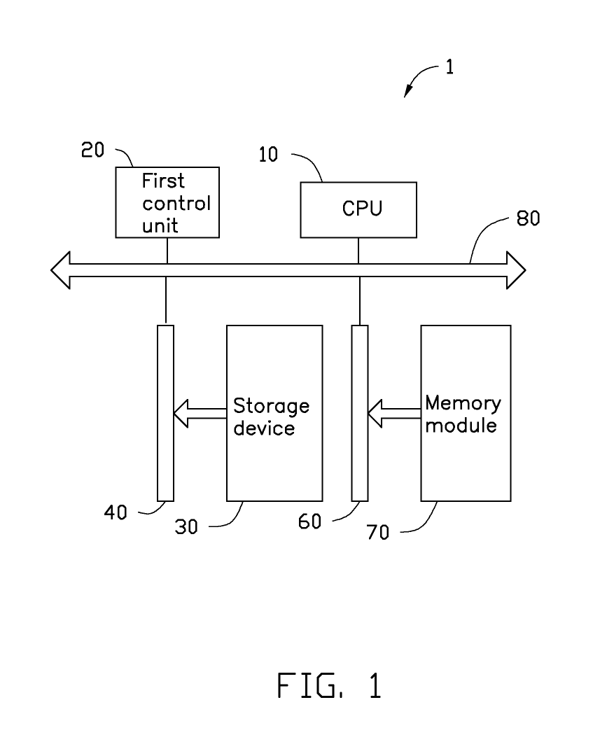

Referring to FIG. 1, an embodiment of a computing system 1 is shown. The computing system 1 includes a central processing unit (CPU) 10, a first control unit 20, a storage device 30, a first dual inline memory module (DIMM) slot 40, a second DIMM slot 60, a memory module 70, and a first bus 80. The storage device 30 is installed on the first DIMM slot 40, and the memory module 70 is inserted on the second DIMM slot 60. The CPU 10, the first control unit 20, the first DIMM slot 40 and the second DIMM slot 60 are connected to the first bus 80. The first DIMM slot 40 is connected to the second DIMM slot 60 through the first bus 80. In the embodiment, the first control unit 20 is a first direct memory access (DMA) controller, and the CPU controls the reading from and writing to the storage device 30 through the first DMA controller.

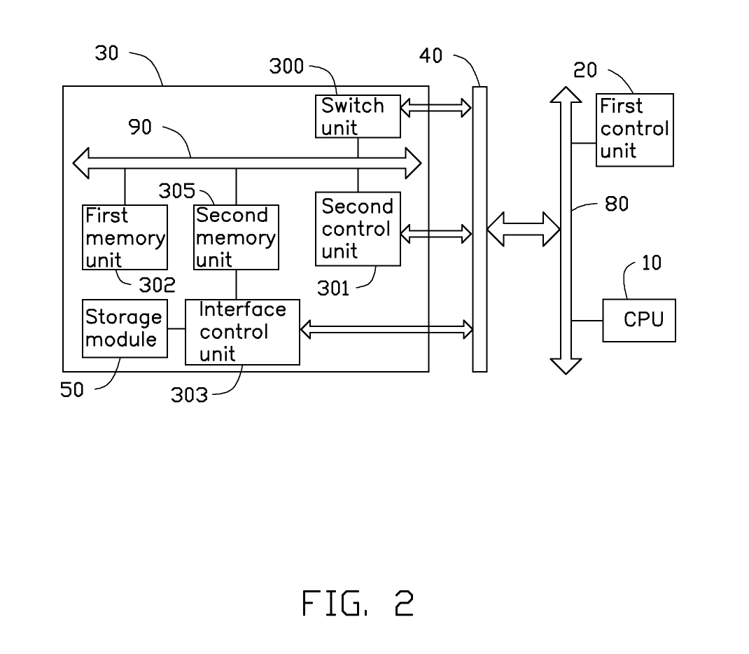

Referring to FIG. 2, an embodiment of a storage device 30 on the computing system 1 is shown. The storage device 30 includes a storage module 50, a second bus 90, a switch unit 300, a second control unit 301, a first memory unit 302, an interface control unit 303, and a second memory unit 305. The switch unit 300, the second control unit 301, the first memory unit 302 and the second memory unit 305 are connected to the second bus 90. The switch unit 300 is also connected to the first bus 80 through the first DIMM slot 40. The storage module 50 is connected to the second bus 90 through the interface control unit 303 and the second memory unit 305. In the embodiment, the second control unit 301 is a second DMA controller and the storage module 50 is a solid-state drive (SSD). In the embodiment, the computing system 1 is connected to the storage device 30 through an empty DIMM slot for controlling the storage device 30.

The first control unit 20 controls a first data transmission between the memory module 70 and the first memory unit 302 when the CPU 10 assigns a first control right to the first bus 80 and a second control right to the second bus 90 to the first control unit 20. In the embodiment, the first control right to the first bus 80 is a right to transfer data through the first bus 90, and the second control right to the second bus 90 is a right to transfer data through the second bus 90. The first control unit 20 releases the first and the second control rights back to the CPU 10 after the first data transmission is ended. In addition, the second control unit 303 controls a second data transmission between the first memory unit 302 and the storage module 50 through the interface control unit 303 when the CPU 10 assigns the second control right to the second control unit 301. The second control unit 301 releases the second control right back to the CPU 10 after the second data transmission is ended.

The switch unit 300 receives a first switch signal and a second switch signal from the CPU 10 to control a connection between the first bus 80 and the second bus 90. When the switch unit 300 receives the first switch signal, the switch unit 300 is turned on and allows the second bus 90 to connect to the first bus 80. Thus, the first control unit 20 controls the first data transmission between the memory module 70 and the first memory unit 302. When the switch unit 300 receives the second switch signal, the switch unit 300 is turned off and disconnects the second bus 90 from the first bus 80. Therefore, the storage device 30 cannot transmit data to the memory module 70 through the first bus 80.

The computing system 1 can include a data bus for transmitting data, a control bus for transmitting a control signal, and an address bus for specifying a physical address. In the embodiment, the switch unit 300 controls the data bus between the storage device 30 and the first DIMM slot 40. In other words, the switch unit 300 can allow or disallow the transmission of data between the first DIMM 40 and the storage device 30. In other embodiments, the switch unit 30 is unnecessary so that the data is directly transmitted between the storage device 30 and the first DIMM slot 40.

The interface control unit 303 controls the storage module 50 when the interface control unit 303 receives a read command or a write command from the CPU 10. For example, the interface control unit 303 can read data from the storage module 50 or write data into the storage module 50. The second memory unit 305 stores data from the storage module 50 and data from the first memory unit 302. When the interface control unit 303 receives a read command, the interface control unit 303 reads the data from the storage module 50 and transmits the data to the second memory unit 305 first. Then, the second control unit 301 reads the data from the second memory unit 305 to store the data in the first memory unit 302. In another embodiment, the second memory unit 305 is included in the interface control unit 303, so the interface control unit 303 reads data from the storage module 50 to directly store the data in the second memory unit 305 of the interface control unit 303. In other embodiments, the storage device 30 does not include the second memory unit 305. Thus, the second control unit 301 reads data from the storage module 50 through the interface control unit 303 to store the data directly into the first memory unit 302.

The first memory unit 302 stores data from the memory module 70 and data from the storage module 50 through the interface control unit 303. When data in the memory module 70 is required to be stored in storage module 50, the first control unit 20 reads the data from the memory module 70, for storage in the first memory unit 302 first. Then, the second control unit 301 reads the data from the first memory unit 302 to store the data into the storage module 50 through the interface control unit 303.

When the CPU 10 performs a read operation on the storage module 50, the CPU 10 transmits the read command to the interface control unit 303 and sets up and initiates the second control unit 301 to control the second data transmission. In the embodiment, the second control unit 301 includes registers, and the CPU 10 sets up the registers of the second control unit 301. The interface control unit 303 reads a first data from the storage module 50 to store the first data in the second memory unit 305. Then, the CPU 10 transmits the second switch signal to turn off the switch unit 300 to disconnect the storage device 30 from the first bus 80. The second control unit 301 obtains the second control right to the second bus 90 from the CPU 10 and reads the first data from the second memory unit 305 to store the first data in the first memory unit 302. In other words, the second control unit 301 reads the first data from the storage module 50 through the interface control unit 303 for storage in the first memory unit 302. When the second data transmission between the storage module 50 and the first memory unit 302 is ended, the second control unit 301 transmits a first interrupt to the CPU 10 and releases the second control right back to the CPU 10. When the CPU 10 receives the first interrupt from the second control unit 301, the CPU 10 transmits the first switch signal to turn on the switch unit 300 so the storage device 30 connects to the first bus 80. The CPU 10 sets up and initiates the first control unit 20, and the first control unit 20 obtains the first and the second control rights from the CPU 10. In the embodiment, the first control unit 20 includes registers, and the CPU 10 sets up the registers of the first control unit 20. Thus, the first control unit 20 reads the first data from the first memory unit 302 through the first bus 80 and the second bus 90 for storage in the memory module 70. When the first data transmission between the first memory unit 302 and the memory module 70 is ended, the first control unit 20 transmits a second interrupt to the CPU 10 and releases the first and the second control rights back to the CPU 10 to end the read operation on the storage module 50.

When the CPU 10 performs a write operation on the storage module 50, the CPU 10 sets up and initiates the first control unit 20 to control the first data transmission, and the first control unit 20 obtains first and second control rights from the CPU 10. The first control unit 20 reads a second data from the memory module 70 for storage in the first memory unit 302 through the first bus 80 and the second bus 90. When the first data transmission between the first memory unit 302 and the memory module 70 is ended, the first control unit 20 transmits a third interrupt to the CPU 10 and releases the first and the second control rights back to the CPU 10. Then, the CPU 10 sets up and initiates the second control unit 301 and transmits the write command to the interface control unit 303. In addition, the CPU 10 transmits the second switch signal to turn off the switch unit 300 to disconnect the storage device 30 from the first bus 80. The second control unit 301 obtains the second control right from the CPU 10 and reads the second data from the first memory unit 302, to store the second data in the second memory unit 305. The interface control unit 303 reads the second data from the second memory unit 305 to store the second data in the storage module 50. In other words, the second control unit 301 reads the second data from the first memory unit 302 for storage in the storage module 50 through the interface control unit 303. When the second data transmission between the first memory unit 302 and the storage module 50 is ended, the second control unit 301 transmits a fourth interrupt to the CPU 10 and releases the second control right back to the CPU 10 to end the write operation on the storage module 50.

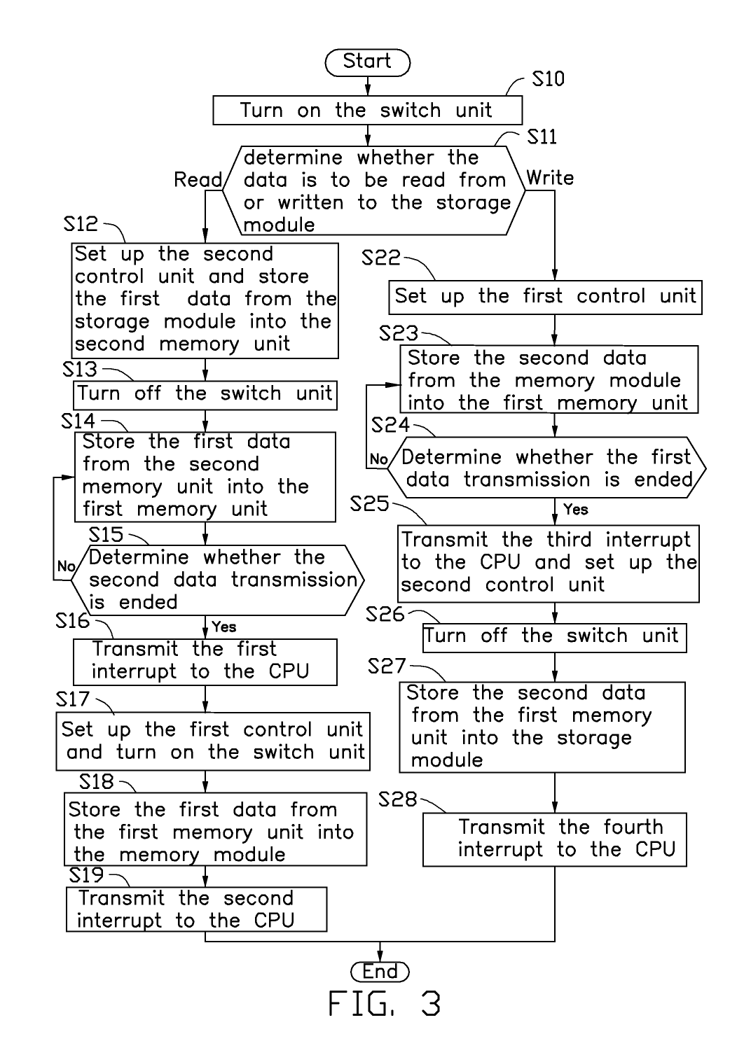

As shown in FIG. 3, an embodiment of the data transmission method is as follows:

In step S10, the CPU 10 transmits the first switch signal to the switch unit 300 to turn on the switch unit 300. Thus, the storage device 30 is allowed to connect to the first bus 80 through the switch unit 300.

In step S11, the CPU 10 determines whether data is to be read from or written to the storage module 50. When the CPU 10 is to perform a read operation on the storage module 50, the procedure goes to step S12. When the CPU 10 is to perform a write operation on the storage module 50, the procedure goes to step S22.

In step S12, the CPU 10 transmits the read command to the interface control unit 303 and sets up the second control unit 301 for a transfer of the first data. The interface control unit 303 reads the first data from the storage module 50 to store in the second memory unit 305.

In step S13, the CPU 10 transmits the second switch signal to the switch unit 300 to turn off the switch unit 300. The storage device 30 thus disconnects from the first bus 80.

In step S14, the second control unit 301 reads the first data from the second memory unit to store in the first memory unit 302.

In step S15, the second control unit 301 determines whether or not the second data transmission between the first memory unit 302 and the storage module 50 is ended. When the second data transmission has been ended, the procedure goes to step S16. When the second data transmission is not yet ended, the procedure returns to step S14.

In step S16, the second control unit 301 transmits a first interrupt to notify the CPU that the second data transmission between the first memory unit 302 and the storage module 50 has been ended.

In step S17, the CPU 10 transmits the first switch signal to the switch unit 300 to turn on the switch unit 300. Thus, the storage device 30 is allowed to connect to the first bus 80 through the switch unit 300. In addition, the CPU 10 sets up the first control unit 20 for the transfer of the first data.

In step S18, the first control unit 20 reads the first data from the first memory unit 302 to store in the memory module 70 through the first bus 80 and the second bus 90.

In step S19, the first control unit 20 transmits a second interrupt to notify the CPU 10 that the first data transmission between the first memory unit 302 and the memory module 70 has been ended. In addition, the first control unit 20 releases the first and the second control rights back to the CPU 10. Accordingly, the read operation on the storage module 50 is completed.

In step S22, the CPU 10 sets up the first control unit 20 for a transfer of the second data.

In step S23, the first control unit 20 reads the second data from the memory module 70 to store in the first memory unit 302 through the first bus 80 and the second bus 90.

In step S24, the first control unit 20 determines whether or not the first data transmission between the first memory unit 302 and the memory module 70 is ended. When the first data transmission has been ended, the procedure goes to step S25. When the first data transmission is not yet ended, the procedure returns to step S23.

In step S25, the first control unit 20 transmits a third interrupt to notify the CPU that the first data transmission between the first memory unit 302 and the memory module 70 has been ended. The CPU 10 transmits the write command to the interface control unit 302 and sets up the second control unit 301 for the transfer of the second data.

In step S26, the CPU 10 transmits the second switch signal to the switch unit 300 to turn off the switch unit 300. The storage device 30 thus disconnects from the first bus 80.

In step S27, the second control unit 301 reads the second data from the first memory unit 302 to store in the storage module 50 through the interface control unit 303.

In step S28, the second control unit 301 transmits a fourth interrupt to notify the CPU 10 that the second data transmission between the first memory unit 302 and the storage module 50 has been ended. Accordingly, the write operation on the storage module 50 is completed.

The above computing system and the data transmission method apply to an external storage device installed on the DIMM slot of the motherboard. Thus, the storage device connecting to the DIMM slot can exchange data with the memory module through the DMA controller. Accordingly, the number of empty DIMM slots is reduced, and the hardware resource utilization of the computing system is improved.

While the disclosure has been described by way of example and in terms of preferred embodiments, it is to be understood that the disclosure is not limited thereto. On the contrary, it is intended to cover various modifications and such similar arrangements as would be apparent to those skilled in the art. Therefore, the range of the appended claims should be accorded the broadest interpretation so as to encompass all such modifications and similar arrangements.

What is claimed is:

1. A computing system, comprising:
a first bus connected to a first dual inline memory module (DIMM) and a second DIMM;
a first control unit connected to the first bus;
a memory module connected to the first bus through the second DIMM; and
a storage device connected to the first bus through the first DIMM, comprising:
a second bus;
a first memory unit connected to the second bus, wherein a first data transmission between the first memory unit and the memory module is controlled by the first control unit;
a storage module;
an interface control unit connected the storage module to the second bus and configured to control the storage module; and
a second control unit connected to the second bus and configured to control a second data transmission between the first memory unit and the storage module.

2. The computing system of claim 1, comprising:
a central processing unit (CPU) connected to the first bus and configured to set up the first control unit and the second control unit to control the first and the second data transmissions.

3. The computing system of claim 2, wherein the storage device comprises a switch unit configured to receive a first switch signal and a second switch signal from the CPU to switch a connection between the first bus and the second bus.

4. The computing system of claim 3, wherein the first bus connects to the second bus when the switch unit receives the first switch signal, and the first bus disconnects from the second bus when the switch unit receives the second switch signal.

5. The computing system of claim 4, wherein the second control unit controls the second data transmission through the second bus when the first bus disconnects from the second bus.

6. The computing system of claim 2, wherein the first control unit is a first direct memory access (DMA) controller, and the first DMA controller controls the first data transmission when the CPU assigns a first control right to the first bus and a second control right to the second bus to the first DMA controller.

7. The computing system of claim 6, wherein the second control unit is a second DMA controller, and the second DMA controller controls the second data transmission when the CPU assigns the second control right to the second DMA controller.

8. The computing system of claim 1, wherein the storage device comprises a second memory unit, and the interface control unit reads first data from the storage module to store in the second memory unit and reads second data from the second memory unit to store in the storage module.

9. The computing system of claim 8, wherein the second control unit reads the first data from the storage module through the interface control unit to store in the first memory unit, and the first control unit reads the first data from the first memory unit to store in the memory module.

10. The computing system of claim 8, wherein the first control unit reads the second data from the memory module to store in the first memory unit, and the second control unit reads the second data from the first memory unit to store in the storage module through the interface control unit.

11. A data transmission method of a computing system including a first bus, a first control unit, a first dual inline memory module (DIMM) and a second DIMM, wherein the method comprising:
connecting the first DIMM to a storage device and connecting the second DIMM to a memory module, wherein the storage device comprises a second bus, a second control unit, an interface control unit, a storage module, and a first memory unit;
reading data from the storage module by the interface control unit to store in the first memory unit through the second bus by the second control unit; and
reading the data from the first memory unit to store in the memory module through the first bus and the second bus by the first control unit.

12. The data transmission method of claim 11, wherein the computing system comprises a central processing unit (CPU) configured to set up the first control unit and the second control unit.

13. The data transmission method of claim 12, wherein the second control unit stores the data into the first memory unit after the CPU sets up the second control unit, and the first control unit reads the data from the first memory unit after the CPU sets up the first control unit.

14. The data transmission method of claim 11, wherein the first bus is disconnected from the second bus when the second control unit stores the data to the first memory unit, and the first bus is connected to the second bus when the first control unit reads the data from the first memory module.

15. The data transmission method of claim 11, wherein the interface control unit reads the data from the storage module to store in a second memory unit, and the second control unit reads the data from the second memory unit to store in the first memory unit through the second bus.

16. A data transmission method of a computing system including a first control unit, a first dual inline memory module (DIMM) and a second DIMM, wherein the method comprising:
connecting the first DIMM to a storage device and connecting the second DIMM to a memory module, wherein the storage device comprises a second control unit, an interface control unit, a storage module, and a first memory unit;
reading data from the memory module to store in the first memory unit by the first control unit; and
reading the data from the first memory unit to store in the storage module by the interface control unit and the second control unit.

17. The data transmission method of claim 16, wherein the second control unit reads the data from the first memory unit to store in a second memory unit of the storage device, and the interface control unit reads the data from the second memory unit to store in the storage module.
